(19) United States
(12) Patent Application Publication
(10) Pub. No.: US 2013/0102698 A1
(43) Pub. Date: Apr. 25, 2013

(54) DUAL CURE ADHESIVES

(71) Applicant: HENKEL CORPORATION, ROCKY HILL, CT (US)

(72) Inventors: JEFFREY LEON, LONG BEACH, CA (US); JEFFREY GASA, LONG BEACH, CA (US); DUNG NGHI PHAN, LONG BEACH, CA (US); GYANENDRA DUTT, GARDEN GROVE, CA (US)

(73) Assignee: HENKEL CORPORATION, ROCKY HILL, CT (US)

(21) Appl. No.: 13/707,891

(22) Filed: Dec. 7, 2012

Related U.S. Application Data
(63) Continuation of application No. PCT/US2011/033763, filed on Apr. 25, 2011.
(60) Provisional application No. 61/352,600, filed on Jun. 8, 2010.

(51) Int. Cl. C09J 163/04

(52) U.S. Cl. CPC C09J 163/04
USPC 522/18

(57) ABSTRACT

This invention is a dual cure adhesive that can be designed to have a proper balance of properties by choosing formulation materials to meet certain inequalities. The dual cure adhesive comprises ethylenically unsaturated compounds capable of UV-initiated free radical polymerization and epoxy compounds and their corresponding curing agents capable of thermal cure. In a particular embodiment, the dual cure adhesive comprises (A) one or more monofunctional acrylate compounds containing an oxygen-containing cyclic unit, (B) one or more monofunctional acrylate compounds in which the ester group contains a hydrocarbon group consisting of at least six carbon atoms, and (C) one or more thermoplastic, solid, amorphous epoxy compounds having a softening point or melting point between 60° C. and 100° C.

### FIELD OF THE INVENTION

This invention relates to adhesives that can undergo both a UV-initiated photopolymerization and a thermally initiated polymerization or cure.

### BACKGROUND OF THE INVENTION

Dual cure adhesives, which can undergo a UV-initiated B-stage photopolymerization followed by a thermal C-stage cure, are class of formulations well suited for semiconductor die attach, and particularly for application in stacked memory chip packages. In the design of such an adhesive, the material properties of tackiness, viscosity, green strength, peel strength, and die shear strength must be balanced. This is not easily accomplished because the range of raw materials available for formulation is large and the fundamental properties of the final composition can be affected by the choice and amount of materials selected. Thus, it would be an advantage to be able to choose appropriate formulation materials without extensive experimentation.

### SUMMARY OF THE INVENTION

This invention is a dual cure adhesive that can be designed to have a proper balance of properties by choosing formulation materials to meet certain inequalities. The dual cure adhesive comprises ethylenically unsaturated compounds capable of UV-initiated free radical polymerization and epoxy compounds and their corresponding curing agents capable of thermal cure. In a particular embodiment, the dual cure adhesive comprises (A) one or more monofunctional acrylate compounds containing an oxygen-containing cyclic unit, (B) one or more monofunctional acrylate compounds in which the ester group contains a hydrocarbon group consisting of at least six carbon atoms, and (C) one or more thermoplastic, solid, amorphous epoxy compounds having a softening point or melting point between 60° C. and 100° C.; in which the compounds meet the following inequalities simultaneously:

+(0.0870×wt % A)−(0.0253×wt % B)−(0.0071×wt % C)≦2

−(299.18965×wt % A)−(286.4803×wt % B)+(367.9926×wt % C)≦2500

+(21.2989×wt % A)−(8.0051×wt % B)+(8.5470×wt % C)−(0.7810×wt % A×wt % C)≦20

−(0.0204×wt % A)−(0.0363×wt % B)+(0.0820×wt % C)≧1

−(0.1538×wt % A)+(0.1613×wt % B)+(0.2581×wt % C)≧5

in which wt % A, wt % B, and wt % C represent the weight percent of the compounds of (A), (B) and (C), respectively, in the dual cure adhesive composition. In one embodiment, compound (C) is soluble in (A) and (B) at a concentration of 20% or greater. In addition to the compounds (A), (B), and (C), the dual cure adhesive will contain curing agents for the acrylates and the epoxies. In some embodiments, the dual cure adhesive will further contain one or more fillers. The dual cure adhesive of claim 1 in which

[symbol]

### DETAILED DESCRIPTION OF THE INVENTION

Adhesives useful in stacked semiconductor die, and similar, packages must have certain material and performance specifications in order to be useful. Important properties include tackiness, viscosity, peel strength, die shear strength, and green strength.

The adhesives should have a tackiness value of 2 or less in the B-staged state. If the value is greater than 2, the adhesive may flow when at room temperature or cooler (cold-flow) and may not release dies from dicing tape substrates easily.

Liquid wafer backside coating formulations are seen as a potentially attractive replacement for film adhesives. In order to be useful with developmental spray coating hardware that is commercially available for this purpose, the formulation viscosity must be below 2500 Pa·s. A preferred viscosity is, therefore, 2500 Pa·s or less.

The B-staged formulation must show sufficient release from UV-treated UV dicing tape. If the peel strength value is above 20 g/inch then the die may crack or split when picked up from the die dicing tape. A peel strength value of less than or equal to 20 g/inch is preferred.

The die shear strength after a thermal simulation of a representative packaging process and measured at 260° C. (reflow oven temperature) gives a good indication of product reliability. A value of less than 1 kg/die indicates a high risk of reliability failure in the final package. A die shear strength of 1 kg force per die or greater is preferred.

The green strength is in indication of how susceptible the bonded dies are to movement, displacement, or peeling during or after the bonding step, but before the curing step. A value of less than 5 kg/die indicates that there is a danger of dies moving or peeling during the process. A green strength of 5 kg force per die or greater is preferred.

The inventors discovered that a critical combination of two different acrylate compounds and at least one epoxy compound could be formulated to provide the performance needed to meet the above criteria. The acrylates are identified as compounds (A) and (B), and the epoxy as compound (C).

Compound (A) is a monofunctional, low viscosity (<200 cps), low volatility (BP>150° C.) acrylate containing an oxygen-containing cyclic unit. Examples of such acrylates include monocyclic acetal acrylate, (meth)acrylates containing cyclic acetals (such as, SR531 available from Sartomer), and tetrahydrofurfuryl acrylate (available SR285from Sartomer).

Compound (B) is a monofunctional, hydrocarbon-rich, low viscosity (<200 cps), low volatility (BP>150° C.) acrylate, in which the ester group contains a linear, cyclic, or branched hydrocarbon group consisting of at least 6 carbons. Examples include isophoryl acrylate and isobornyl acrylate.

Compound (C) is thermoplastic, solid, amorphous epoxy resin, having a softening point or melting point between 60° C. and 100° C. and being soluble in moderate-polarity solvents. Examples include those selected from the group consisting of cresol novolac epoxy, phenol novolac epoxy, bisphenol-A epoxy, and glycidylated cyclopentadiene/phenol adduct resins. Examples of moderate-polarity solvents include ester solvents (such as ethyl and butyl acetate), tetrahydrofuran, methylene chloride, chloroform, glycol esters and glycol ethers.

Suitable curing agents for the epoxy resin are present in an amount between greater than 0 and 50 wt % and include, but are not limited to, phenolics, aromatic diamines, dicyandiamides, peroxides, amines, imidizoles, tertiary amines, and polyamides. Suitable phenolics are commercially available from Schenectady International, Inc. Suitable aromatic diamines are primary diamines and include diaminodiphenyl sulfone and diaminodiphenyl methane, commercially available from Sigma-Aldrich Co. Suitable dicyandiamides are available from SKW Chemicals, Inc. Suitable polyamides are commercially available from Air Products and Chemicals, Inc. Suitable imidazoles are commercially available from Air Products and Chemicals, Inc. Suitable tertiary amines are available from. Sigma-Aldrich Co.

Suitable curing agents for acrylate resins are present in an amount between 0.1 and 10 wt % and include, but are not limited to, any of the known acetophenone-based, thioxanthone-based, benzoin-based and peroxide-based photoinitiators. Examples include diethoxyacetophenone, 4-phenoxydichloroacetophenone, benzoin, benzoin ethyl ether, benzoin isopropyl ether, benzyl dimethyl ketal, benzophenone, 4-phenyl benzophenone, acrylated benzophenone, thioxanthone, 2-ethylanthraquinone, etc. The Irgacur and Darocur lines of photoinitiators sold by BASF are examples of useful photoinitiators.

One or more nonconductive fillers may be used in the adhesive. Examples of suitable nonconductive fillers include alumina, aluminum hydroxide, silica, vermiculite, mica, wollastonite, calcium carbonate, titania, sand, glass, barium sulfate, zirconium, carbon black, organic fillers, and organic polymers including but not limited to halogenated ethylene polymers, such as, tetrafluoroethylene, trifluoroethylene, vinylidene fluoride, vinyl fluoride, vinylidene chloride, and vinyl chloride.

In order to determine the constraints for obtaining formulations that have the optimum balance of performance properties, a D-optimal 23-run mixture statistical design of experiment was conducted using the compounds and weight percentages described in Table 1. The levels of filler; photoinitiator, and epoxy hardener were kept constant for all formulations.

TABLE 1
FORMULATION COMPONENTS AND AMOUNTS

| Component | Role | Wt % Range |
|---|---|---|
| (A) tetrahydrofurfuryl | acrylate containing an | 25.33-38.00% |
| acrylate (available as SR285 | oxygen-containing | |
| from Sartomer) | cyclic unit | |
| (B) isophoryl acrylate | hydrocarbon-rich | 0-19.00% |
| (available as CD420 from | acrylate | |
| Sartomer) | | |
| (C) cresyl novolac epoxy | rigid, oligomeric, | 0-50.67% |
| resin (available asN685 | epoxy with | |
| from Dainippon Ink and | moderate melting | |
| Chemicals) | point (about 85° C.) | |
| (D) glycidylated | soft, oligomeric | 0-50.67% |
| cyclopentadiene/phenol | epoxy resin | |
| adduct (available as Epiclon | | |
| HP7200 from Japan Epoxy | | |
| Resins) | | |
| fused silica | filler | 20.00%% |
| (dry sieved at 5 microns) | | |
| equal parts by weight of | photoinitiator | 3.00% |
| 2,4,6-trimethylbenzoyl- | | |
| diphenyl-phosphineoxide | | |
| and 2-hydroxy-2-methyl-1- | | |
| phenyl-propan-1-one | | |
| 2-phenyl-4-methylimidazole | epoxy hardener | 1.00% |
| Additional constraints | | 25.33 ≦ A + B ≦ 38.00 |
| | | 0 ≦ A + B + C + D ≦ |
| | | 76.00 |

The program used to design the experimental formulations was Design Expert V. 7.1.6, sold by Stat Ease Corporation of Minneapolis, Minn. The program output gave 23 experimental formulations containing the levels of compounds (A), (B), (C), and (D) shown in Table 2. (Later, compound (D), the glycidylated cyclopentadiene/phenol adduct epoxy resin (HP7200) was found to give chronic reliability problems and was removed from consideration in this experiment.)

TABLE 2
WT % OF COMPONENTS FOR DESIGN FORMULATIONS

| Run | Point type | A (%) | B (%) | C (%) | D (%) |
|---|---|---|---|---|---|
| 1 | Center Edge | 19.00 | 6.33 | 25.34 | 25.34 |
| 2 | Third Edge | 19.00 | 19.00 | 12.67 | 25.33 |
| 3 | Third Edge | 25.33 | 0.00 | 33.78 | 16.89 |
| 4 | Center | 25.33 | 6.33 | 22.17 | 22.17 |
| 5 | Plane Center | 31.67 | 0.00 | 22.17 | 22.17 |
| 6 | Vertex | 25.33 | 0.00 | 0.00 | 50.67 |
| 7 | Vertex | 25.33 | 0.00 | 0.00 | 50.67 |
| 8 | Vertex | 38.00 | 0.00 | 0.00 | 38.00 |
| 9 | Center Edge | 28.50 | 9.50 | 0.00 | 38.00 |
| 10 | Vertex | 25.33 | 0.00 | 50.67 | 0.00 |
| 11 | Third Edge | 19.00 | 10.55 | 0.00 | 46.45 |
| 12 | Center | 25.33 | 6.33 | 22.17 | 22.17 |
| 13 | Vertex | 19.00 | 19.00 | 38.00 | 0.00 |
| 14 | Center | 25.33 | 6.33 | 22.17 | 22.17 |
| 15 | Third Edge | 19.00 | 19.00 | 25.33 | 12.67 |
| 16 | Vertex | 19.00 | 19.00 | 0.00 | 38.00 |
| 17 | Vertex | 38.00 | 0.00 | 38.00 | 0.00 |
| 18 | Vertex | 38.00 | 0.00 | 38.00 | 0.00 |
| 19 | Vertex | 38.00 | 0.00 | 0.00 | 38.00 |
| 20 | Center Edge | 19.00 | 6.33 | 25.34 | 25.34 |
| 21 | Axial CB | 25.33 | 3.17 | 11.08 | 36.42 |
| 22 | Vertex | 25.33 | 0.00 | 50.67 | 0.00 |
| 23 | Center Edge | 28.50 | 9.50 | 38.00 | 0.00 |

The formulations were prepared as follows: The two epoxy components (C) and (D) were dissolved in the required amounts of tetrahydrofurfuryl acrylate (A) at 80° C. The solution was cooled to room temperature and the remaining components were added. The mixture was hand-mixed and then passed four times through a three-roll ceramic mill All formulations were free-flowing tan liquids.

The experimental outputs were tackiness, viscosity, dicing tape peel strength, green strength, die shear strength (after process simulation), and warpage. All 23 formulations were tested for these outputs by the following testing methods.

Tackiness: A 50 micron layer of B-staged formulation was prepared and UV B-staged on a ceramic tablet as described for the peel strength procedure, except that the strips each consisted of only one layer of tape. A gloved finger was pressed onto the B-staged adhesive surface with a force of 100-150 g for approximately a second and then withdrawn. The following rating system was used.
0: No sticking or resistance is felt when gloved finger is removed.
1: No sticking or resistance is felt when finger is removed, but visible specks are seen on the surface.
2: No sticking or resistance is felt when gloved finger is removed, but a barely visible imprint is left on the surface
3: Slight sticking or resistance is felt when gloved finger is removed and a visible imprint is left on the surface
4: Glass slide sticks to glove for a couple of seconds when gloved finger is removed and a visible imprint is left on the surface.
5: Glass slide sticks to glove until it is pulled free. Relatively strong resistance is felt when gloved finger is removed and a visible imprint is left on the surface.

Viscosity: A 0.5 cc sample was measured for viscosity at 25° C. and 5 RPM with spindle number CPE-51 using a Brookfield Engineering Laboratories, INS viscometer; model HBDV-III+CP.

Dicing tape peel strength: 4 pieces of 8 in.×0.5 in. clear tape were combined in two parallel two-layer strips (approximately 8 inches, approximately 100 microns thickness total) and the combinations laid down on 2 in.×5 in. flat ceramic tablet at a separation of approximately 1.5 inches. Formulation, 5 cc, was dispensed in a small blob between the tape strips at the top edge. A layer of formulation was formed between the tape strips by holding a microscope slide at a 45° vertical angle to the tablet and drawing it down over the formulation like a squeegee. The tablet was passed through a Fusion belt-driven mercury lamp using a belt speed of approximately 104 cm/min, an intensity of 0.381 W/cm, and a total exposure of 1.4 J/cm² to UV B-stage the formulation. A 1 in.×8 in. strip of DENKA 8005 dicing tape was laminated at room temperature to the B-staged adhesive using pressurized ceramic rollers. The dicing tape was debonded by passing the laminated tablet through the Fusion lamp at a total exposure of 0.3 J/ cm². Peel strength measurements were performed using a Model 80-91-00-001 Peel Strength Tester instrument (sold by the TMI Group).

Green strength: Two strips of 8 in.×0.5 in. clear tape (approximately 8 inches, approximately 50 microns thickness total) were taped parallel on a 0.5 in.×6 in. pre-bake organic BT substrate with 200-300 microns separation. Approximate 0.5 cc sample was dispensed in between the tape strips at the top edge. The formulation was spread out evenly between the tape strips by using a microscope slide at a 45° vertical angle to the BT substrate and drawing it down over the formulation like a squeegee. The substrate was passed through a Fusion belt-driven mercury lamp using a belt speed of approximately 104 cm/min, an intensity of 0.381 W/cm, and a total exposure of 1.4 J/ cm² to UV B-stage the formulation. The substrate with adhesive was cut into many pieces of 0.5 in.×0.5 in. A 150×150 mm silicon die was placed on the adhesive substrate and the die was attached at 120° C./1 Kg Force/1 sec using Texture Analyser Model TEXTPlus (sold by Texture Technologies Corporation). The die shear measurements were performed at room temperature using DAGE 4000 PA, base Model 4000wsxy50 with hot plate Model 4000AP012-A.

Die shear strength (after process simulation): This preparation method was the same as the green strength measurement, except that after die attach the completed substrate was cured under two conditions: 1) post-cure 30 minute ramp at 150° C. for one hour; 2) post-mold-cure 30 minute ramp at 175° C. for two hours. The die shear was performed at 260° C. using DAGE 4000 PA, base Model 4000wsxy50 with and hot plate Model 4000AP012-A.

The data for each of the five performance responses for the 23 samples was input into the program and each was fit to the statistical model (Table 3). For the peel strength this was a reduced quadratic model. For the other responses it was the linear model. The highest calculated value for “p-value prob>F” was 0.0039, for the green strength response. This indicates that all models are significant and show good signal-to-noise. The performance equations in Table 3 were calculated giving each response as a function of the formulation components. (Compound (D), the glycidylated cyclopentadiene/phenol adduct epoxy resin (HP7200), was removed from consideration. The equations were reached with component D terms set to zero.) (The letter X represents multiplication.)

TABLE 3
PERFORMANCE EQUATIONS

| Performance | | F | p-value | |
|---|---|---|---|---|
| metric | Model | value | prob > F | Equation |
| Tackiness | linear | 12.23 | 0.0001 | = (0.0870 × A) − (0.0253 × B) − (0.0071 × C) |
| Viscosity | linear | 15.80 | ≦0.0001 | = −(299.18965 × A) − (286.4803 × B) + |
| (Brookfield, | | | | (367.9926 × C) |
| 5 RPM) | | | | |
| Peel | Reduced | 4.68 | ≦0.0001 | = (21.2989 × A) − (8.0051 × B) + (8.5470 × |
| strength | quadratic | 4.68 | 0.0001 | C) − (0.7810 × A × C) |
| DSS (EOL) | linear | 7.45 | 0.0017 | = −(0.0204 × A) − (0.0363 × B) + (0.0820 × |
| @ 260° C. | | | | C) |
| Green | linear | 39.39 | 0.0039 | = −(0.1538 × A) + (0.1613 × B) + (0.2581 × |
| strength | | | | C) |

The F Value or F ratio is the test statistic used to decide whether the sample means are withing sampling variability of each other. The “P-value prob>F” is the chance that the F value could occur due to noise. The lower this value, the lower the signal-to-noise.

As discussed above, the preferred performance values are the following: the tackiness value is 2 or less; the formulation viscosity value is 2500 cps or below; the peel strength value is 20 g/inch; the die shear strength is 1 kg force per die or greater; the green strength value is 5 kg force per die or greater.

When these values are combined with the equations in Table 3, the inequalities disclosed in Table 4 are obtained. Adhesive formulations that simultaneously fulfill these five inequalities will be intrinsically useful as die attach adhesives, and particularly useful for stacked die memory packages.

TABLE 4
INEQUALITIES AS LIMITATIONS ON FORMULATIONS

| Performance | | Value | |
|---|---|---|---|
| metric | Units | required | Inequality |
| Tackiness | none | ≦2 | +(0.0870 × wt % A) − (0.0253 × wt % |
| | | | B) − (0.0071 × wt % C) ≦ 2 |
| Viscosity | | | −(299.18965 × wt % A) − (286.4803 × |
| (Brookfield, | cps | ≦2500 | wt % B) + (367.9926 × wt % C) ≦ 2500 |
| 5 RPM) | | | |
| Peel strength | g/inch | ≦20 | +(21.2989 × wt % A) − (8.0051 × wt % |
| | | | B) + (8.5470 × wt % C) − (0.7810 × wt % |
| | | | A × wt % C) 20 |
| DSS (EOL) | kg/die | ≧1 | −(0.0204 × wt % A) − (0.0363 × wt % |
| @ 260° C. | | | B) + (0.0820 × wt % C) > 1 |
| Green | kg/die | ≧5 | −(0.1538 × wt % A) + (0.1613 × wt % |
| strength | | | B) + (0.2581 × wt % C) ≧ 5 |

1. A dual cure adhesive comprising
(A) one or more monofunctional acrylate compounds containing an oxygen-containing cyclic unit,
(B) one or more monofunctional acrylate compounds in which the ester group contains a hydrocarbon group consisting of at least six carbon atoms, and
(C) one or more thermoplastic, solid, amorphous epoxy compounds having a softening point or melting point between 60° C. and 100° C.;
in which the (A), (B) and (C) compounds meet the following inequalities simultaneously:
+(0.0870×wt % A)−(0.0253×wt % B)−(0.0071×wt % C)≦2
−(299.18965×wt % A)−(286.4803×wt % B)+(367.9926×wt % C)≦2500
+(21.2989×wt % A)−(8.0051×wt % B)+(8.5470×wt % C)−(0.7810)×(wt % A ×wt % C)≦20
−(0.0204×wt % A)−(0.0363×wt % B)+(0.0820×wt % C)≧1
−(0.1538×wt % A)+(0.1613×wt % B)+(0.2581×wt % C)≧5
in which wt % A, wt % B, and wt % C represent the weight percent of the compounds of (A), (B) and (C), respectively, in the dual cure adhesive composition;
(D) one or more curing agents for (A), (B), and (C);
(E) one or more non-conductive fillers.

2. The dual cure adhesive of claim 1 in which (A) has a viscosity of <200 cps, and a boiling point of >150° C.

3. The dual cure adhesive of claim 1 in which (A) is a monocyclic acetal acrylate or methacrylate, or tetrahydrofurfuryl acrylate.

4. The dual cure adhesive of claim 1 in which (B) is isophoryl acrylate or isobornyl acrylate.

5. The dual cure adhesive of claim 1 in which (C) is selected from the group consisting of cresol novolac epoxy, phenol novolac epoxy, bisphenol-A epoxy, and glycidylated cyclopentadiene/phenol adduct resins.

6. The dual cure adhesive of claim 1 in which compound (C) is soluble in (A) and (B) at a concentration of 20% or greater.
